(19) United States
(12) Patent Application Publication
(10) Pub. No.: US 2013/0040114 A1
(43) Pub. Date: Feb. 14, 2013

(54) Invertible Camouflage Construction

(71) Applicants: Gregory D. Culler, Nottingham, PA (US); Joanne G. Pheris, Bear, DE (US); Joan M. Regester, Oxford, PA (US)

(72) Inventors: Gregory D. Culler, Nottingham, PA (US); Joanne G. Pheris, Bear, DE (US); Joan M. Regester, Oxford, PA (US)

(21) Appl. No.: 13/547,734

(22) Filed: Jul. 12, 2012

Related U.S. Application Data
(60) Provisional application No. 61/521,982, filed on Aug. 10, 2011.

(51) Int. Cl. F41H 3/00; B32B 27/36; B23P 11/00; B32B 3/10

(52) U.S. Cl. 428/197; 428/201; 29/428

(57) ABSTRACT

An invertible camouflage construction containing a base and two sided garnish is described herein. In an embodiment, the first side of the garnish includes a first pattern, and the second side includes a second pattern visibly distinct from the first pattern. The first side and second side are inverted to provide concealment in differing environments.

### RELATED APPLICATION

The present application claims the benefit of commonly owned and co-pending U.S. Provisional Application No. 61/521,982 filed Aug. 10, 2011.

### BACKGROUND

Camouflaged materials used to conceal objects, personnel, and equipment in natural terrain, and are typically in the form of drapable sheets of varying shapes and sizes. Camouflaged materials may be dyed or printed in patterns to simulate the coloration or texture of the terrain in which the camouflage is used. Typical examples of colors that may be employed include various patterns of black, brown, and green.

Camouflage nets are generally known, in which leaf-cut material or material which has been perforated in some way is attached to a net structure, generally known as a base. Typically, these nets are constructed in a manner such that a substantial percentage of the leaf cut material (typically 30% of greater) is attached to the base, and is attached on portions throughout the length and width of the base. Because there is such a substantial attachment to the base, inversion of the base layer and leaf-cut material while in use is difficult or impossible.

Prior art camouflage nets have been developed that provide printed patterns on one side to provide shielding or disguise, but no additional pattern on the opposite side. Additionally, there have also been prior art camouflage nets, which provide a different printed pattern on each side of the net.

However, these prior constructions are not desirable in many instances because they are not invertible, they are not easily reversible because they must be completely removed from where they are hanging or posted, completely taken off and then flipped over to reverse the camouflage pattern, and because they snag easily because a substantial percentage of the leaf cut material is attached directly to the base, increasing the probably of snagging etc.

Thus, there remains a need in the art for a camouflage netting construction that is fully invertible, easily reversible, and that minimizes snagging during use.

### SUMMARY OF INVENTION

An invertible camouflage construction containing a base and two sided garnish is described herein. The first side of the garnish includes a first pattern, and the second side includes a second pattern visibly distinct from the first pattern. The base layer is attached to the garnish in a configuration that is adapted for allowing inversion of the base layer with the garnish to swap the positions of the first pattern and second pattern in relation to the base layer.

The base layer may be composed of a polymer such as polyester tricot knit or nylon. The garnish layer may also be composed of a polymeric material such as PTFE, fluorinated ethylene propylene, perfluro-alkoxy copolymer resin, polypropylene, or polyethylene, and may be microporous.

The base layer includes a perimeter region, defined by perimeter sides, which are defined by a perimeter attachment means.

The base layer may be attached to the garnish at a plurality of the plurality of perimeter sides. For example, at a number of perimeter sides less than the total number of perimeter sides.

Further, an amount between a positive numerical amount and about 10% of the base layer is attached to the garnish in some embodiments, up to about 5% in others.

In an embodiment, the first side of the garnish is adapted to provide concealment in a visibly woodland, tropical, urban, forest, or desert environment. In another embodiment the second side of the garnish is adapted to provide concealment in a visibly woodland, tropical, urban, forest, or desert environment. The first side and second side may be adapted to provide concealment for different environments.

A method of providing a camouflage construction is also provided. The method includes providing a base layer; providing a garnish comprising a first side and a second side; and attaching the base layer to the garnish layer garnish in a configuration that is adapted for allowing inversion of the base layer with the garnish layer to swap the position of the first side and second side in relation to the base layer. The method may further include inverting the base layer and the garnish layer.

### BRIEF DESCRIPTION OF DRAWINGS

FIG. 1. is a perspective view of the base layer of a camouflage construction

FIG. 2. is a perspective view of the camouflage construction.

FIG. 3. is a perspective view of the camouflage construction.

FIG. 4 is a view of the association of the base layer with the garnish utilizing toggles.

FIG. 5 is a perspective view of a pillowcase attachment arrangement of the base layer and garnish.

### DETAILED DESCRIPTION

The invention related to invertible camouflage constructions comprising a base layer and a garnish layer minimally attached to the base layer. The garnish layer includes a first pattern on one side, and a second distinct pattern on the other side. The first pattern and second pattern may be inverted to swap the position of the first pattern and second pattern in relation to the base layer.

The invention will be described with reference to the following description and figures which illustrate certain embodiments. It will be apparent to those skilled in the art that these embodiments do not represent the full scope of the invention which is broadly applicable in the form of variations and equivalents as may be embraced by the claims appended hereto. Furthermore, features described or illustrated as part of one embodiment may be used with another embodiment to yield still a further embodiment. It is intended that the scope of the claims extend to all such variations and embodiments.

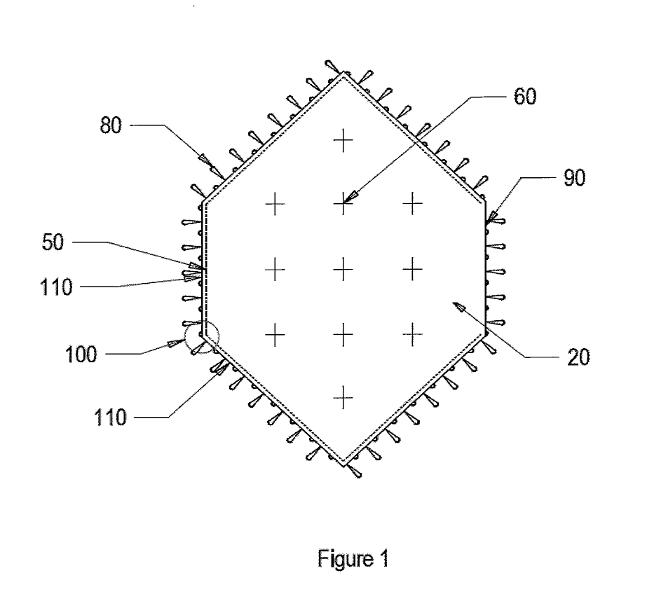

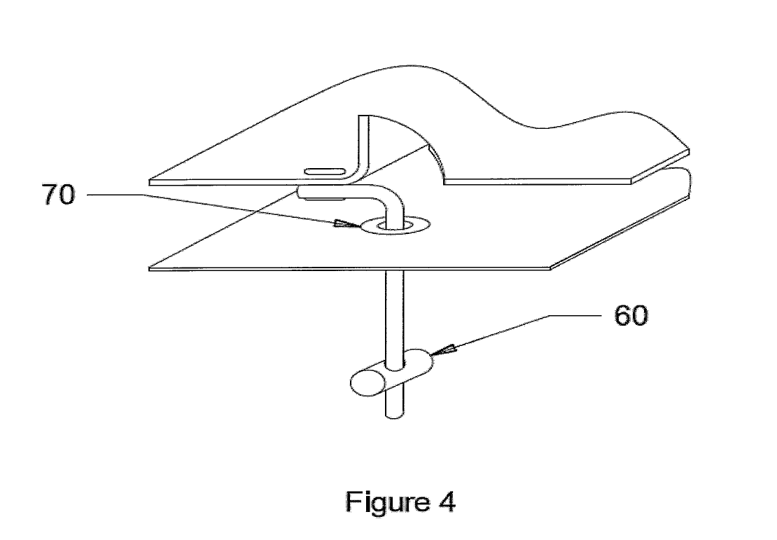

Turning to FIG. 1, a perspective view of the base layer 20 of camouflage construction 10 is illustrated. The base layer as shown has a hexagonal shape, but it may be any shape suitable for use within a camouflage construction suitable for concealment. The base layer may be composed of a variety of materials. Non limiting examples of suitable material are polymeric materials, including polyester tricot knit or nylon. The base layer may include a plurality of locations where toggles (adjustable fasteners) 60 may be utilized. The toggles function to associate the garnish layer 25 (to be described below) with the base layer, but do not directly attach the base layer with the garnish layer. In use, the toggles are inserted in holes defined by grommets which prevent wear and tear on the materials. (See FIG. 4) For purposes of this disclosure attachment is defined as fixedly joining two of more components together in a non-adjustable manner (i.e. stitching).

Returning to FIG. 1, the base layer includes a perimeter region 100 defined by a plurality of perimeter sides 110. Those perimeter sides may be defined by perimeter attachment means 50, such as, for example, stitching.

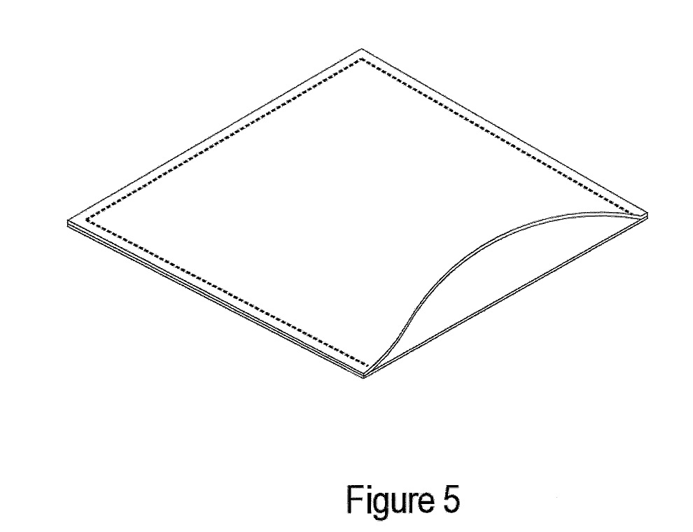

Regardless of the attachment means used, in an embodiment of the invention, the base layer 20 is attached to the garnish 25 at a number of perimeter sides less than the total number of perimeter sides. For example, if there are four perimeter sides, then the garnish is attached to one perimeter side, two perimeter sides, or three perimeter sides, but never all four perimeter sides. An exemplary unattached side is illustrated by reference numeral 90. In certain embodiments, as illustrated in FIG. 5, a “pillow case” construction is utilized wherein only 3 of 4 perimeter sides are attached to the garnish.

This arrangement allows easy inversion of the camouflage construction (which may be of substantial size) without removing the entire construction from where it is hanging or posted.

In an embodiment of invention, an amount between a positive numerical amount and about 10% of the base layer is attached to the garnish. In another embodiment, an amount between a positive numerical amount and about 5% of the base layer is attached to the garnish. In another embodiment, the camouflage construction is not suitable for use as a garment.

Returning to FIG. 1, Becket loops 80, as known in the art, may also be utilized. They are generally attached to the perimeter region of the base and allow for hanging or posting of the camouflage construction.

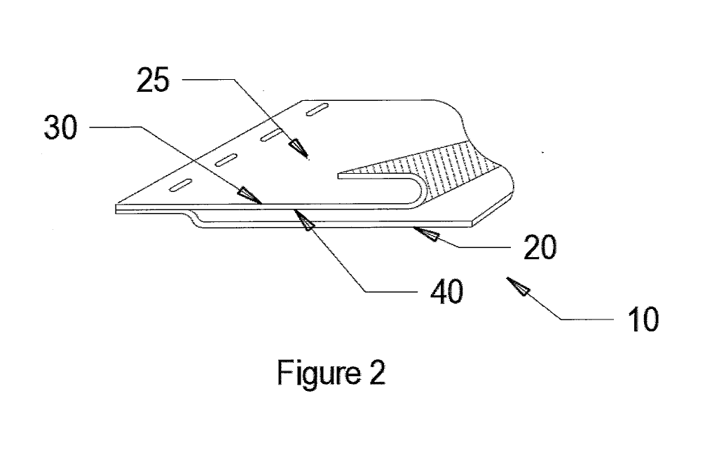

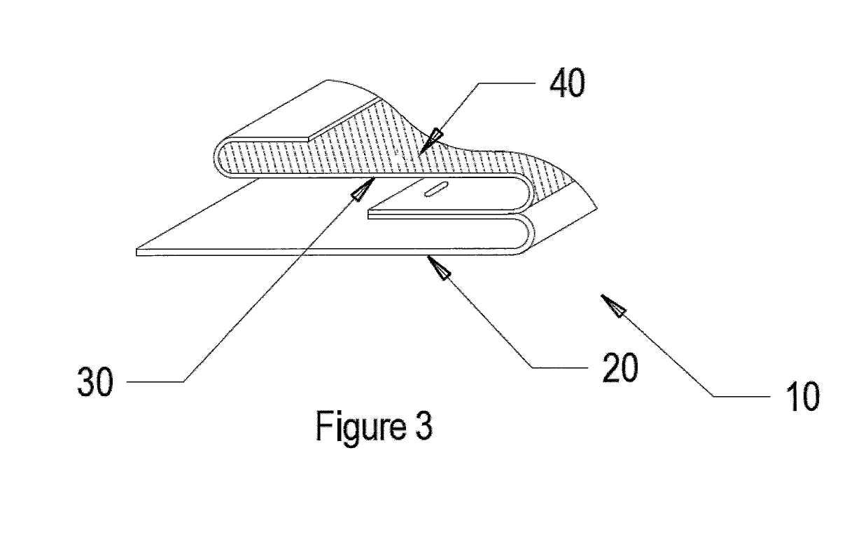

Turning to FIGS. 2, 3, and 4, the garnish 25 is illustrated. The garnish contains a first side 30 and a second side 40. In an embodiment of the invention, both the first side and the second side of the garnish contain various patterns. Non-limiting examples of these patterns include visibly woodland, tropical, urban, forest, or desert. These patterns are adapted to provide concealment in a visibly woodland, tropical, urban, forest, or desert environment.

Additional patterns are also contemplated as long as they are adapted to provide concealment in a defined environment.

The garnish and/or patterns of the garnish may be for formed from a wide variety of materials. These materials may include polytetrafluoroethylene (PTFE), microporous expanded PTFE (ePTFE), fluorinated ethylene propylene (FEP), perfluoroalkoxy copolymer resin (PFA), and polyolefins, including polypropylene and polyethylene. The polymeric material may be porous or microporous, or monolithic. The term microporous, as used herein, can describe the structure of microporous polymer layers having a node and fibril microstructure similar microporous polymeric materials described in and formed by the methods described in U.S. Pat. No. 3,953,566, the description and methods of which are hereby incorporated by reference. Other suitable microporous polymeric layers may a microstructure similar to that depicted in U.S. Pat. Nos. 4,539,256; 4,726,989; or 4,863,792, which are also incorporated by reference. A microporous structure of a polymer introduces many polymer/air interfaces (e.g. pores) that reduce the optical transparency of the polymer in the visible wavelength (described below) region. This can increase the whiteness of an otherwise clear or translucent polymer layer.

The polymeric materials may be a continuous or discontinuous polymeric film. The polymeric material comprises a polymeric layer which may comprise polymeric films or fibers. Material thickness, index of refraction, and porosity of the polymeric material may be selected to achieve desired levels of visual opacity and thermal transparency for concealment. Polymeric layers having thickness of greater than 5 microns may be suitable for certain applications. In other embodiments, polymeric layers greater than about 20 microns, greater than about 40 microns, or greater than about 100 microns may be suitable.

Colorant may be used to affect the concealment effectiveness and properties of the garnish. The colorant may be comprised of one or more additives that absorb, refract, and/or reflect light. The colorant may be disposed on either the first side or second side of the garnish within the polymeric material, or disposed on both the first and second surfaces of the garnish within the polymeric material. The colorant may comprise one or more dyes including, but not limited to acid dyes, disperse dyes, mordant dyes, and solvent dyes. The colorant may comprise one or more pigments including, but not limited to carbon pigments, cadmium pigments, iron oxide pigments, zinc pigments, arsenic pigments, and organic pigments. The colorant may be applied as an ink, toner, or other appropriate print media to deliver the dye or pigment onto or into the polymeric substrate. Ink suitable for use in the present invention may be solid, aqueous, or solvent based.

Further, to this end, the pattern, regardless of which pattern or material is used, may, in an embodiment of the invention provide selective reflectance, as known in the art, and as described in U.S. Pat. Pub. 2009/0214852 to Kelsey et al. which is herein incorporated by reference in its entirety, for visible as defined as 400 nm-600 nm, for nIR as defined to be 700 nm-1000 nm, for MWIR as defined to be 3 micrometers to 5 micrometers and for LWIR as defined to be 9 micrometer to 12 micrometer wavelengths.

The garnish may be utilized as a solid material, as a plurality of fingers or strips or in any other suitable configuration for providing concealment.

In an embodiment of the invention, the first side of the garnish contains a different pattern from the second side of the garnish. This allows the garnish to be able to provide concealment in different environments. For example, the first side could contain a woodland pattern, while the second side could contain a desert pattern. When inverted, the opposite would then be true. Further, the first side could provide selective reflectance for a visible wavelength and the second side provide selective reflectance for nIR.

In addition to the camouflage construction, methods of utilizing the camouflage construction are described herein. In one method, a base layer is provided, a garnish is then provided, the garnish including a first side and a second side. The base layer is then attached to the garnish layer (as described above) in a manner which allows inversion of the base layer with the garnish layer.

In this manner, the first side of the garnish layer swaps position with the second side of the garnish layer. In some embodiments where the first side and second side contain different patterns, this providing concealment for a different environment. However, in some embodiments the first side and second side may have the same pattern or only one of the first and second sides may contain a pattern.

Further, prior to inversion of the first side and second the toggles and beckett loops described above may need to loosed as appropriate to allow inversion of the base layer with the garnish layer, similar to the manner in which a pillowcase for sleeping is inverted (See FIG. 5).

1. A camouflage construction comprising:
a base layer; and
a garnish comprising a first side and a second side, wherein the first side comprises a first pattern and wherein the second side comprises a second pattern visibly distinct from the first pattern, wherein the base layer is attached to the garnish in a configuration that is adapted for allowing inversion of the base layer with the garnish to swap the positions of the first pattern and second pattern in relation to the base layer.

2. The camouflage construction of claim 1, wherein the base layer comprises a polymer.

3. The camouflage construction of claim 2, wherein the polymer is a polyester tricot knit or nylon.

4. The camouflage construction of claim 1, wherein the garnish comprises a polymeric material

5. The camouflage construction of claim 4, wherein the polymeric material comprises PTFE.

6. The camouflage construction of claim 4, wherein the polymeric material is fluorinated ethylene proplylene, perfluro-alkoxy copolymer resin, polypropylene, or polyethylene.

7. The camouflage construction of claim 4 wherein the polymeric material is microporous.

8. The camouflage construction of claim 1, wherein a perimeter region is defined within the base layer.

9. The camouflage construction of claim 8, wherein the perimeter region defines a plurality of perimeter sides.

10. The camouflage construction of claim 9, wherein the perimeter sides are defined by a perimeter attachment means.

11. The camouflage construction of claim 9, wherein the base layer is attached to the garnish at a plurality of the plurality of perimeter sides.

12. The camouflage construction of claim 9, wherein the base layer is attached to the garnish at a number of perimeter sides less than the total number of perimeter sides.

13. The camouflage construction of claim 1, wherein an amount between a positive numerical amount and about 10% of the base layer is attached to the garnish.

14. The camouflage construction of claim 13, wherein an amount between a positive numerical amount and about 5% of the base layer is attached to the garnish.

15. The camouflage construction of claim 1, wherein the first side of the garnish is adapted to provide concealment in a visibly woodland, tropical, urban, forest, or desert environment.

16. The camouflage construction of claim 1, wherein the second side of the garnish is adapted to provide concealment in a visibly woodland, tropical, urban, forest, or desert environment.

17. The camouflage construction of claim 1, wherein the second side of the garnish is adapted to provide concealment in a different environment than the first side of the garnish.

18. A method of construction a camouflage construction comprising:
providing a base layer;
providing a garnish comprising a first side and a second side; and
attaching the base layer to the garnish layer garnish in a configuration that is adapted for allowing inversion of the base layer with the garnish layer to swap the position of the first side and second side in relation to the base layer

19. A method of using a camouflage construction, said method comprising
providing a base layer;
providing a garnish comprising a first side and a second side; and
attaching the base layer to the garnish layer garnish in a configuration that is adapted for allowing inversion of the base layer with the garnish layer to swap the position of the first side and second side in relation to the base layer, and
inverting the base layer and the garnish layer.
